(19) United States
(12) Patent Application Publication
(10) Pub. No.: US 2018/0082373 A1
(43) Pub. Date: Mar. 22, 2018

(54) REAL-TIME DEMAND BIDDING FOR ENERGY MANAGEMENT IN DISCRETE MANUFACTURING SYSTEM

(71) Applicant: INDUSTRY-UNIVERSITY COOPERATION FOUNDATION HANYANG UNIVERSITY ERICA CAMPUS, Ansan-si (KR)

(72) Inventors: Seung-Ho HONG, Seoul (KR); Yi Chang LI, Ansan-si (KR)

(73) Assignee: INDUSTRY-UNIVERSITY COOPERATION FOUNDATION HANYANG UNIVERSITY ERICA CAMPUS, Ansan-si (KR)

(21) Appl. No.: 15/616,475

(22) Filed: Jun. 7, 2017

(30) Foreign Application Priority Data
Sep. 19, 2016 (KR) 10-2016-0119343
Mar. 10, 2017 (KR) 10-2017-0030315

(51) Int. Cl. G06Q 40/04; G06Q 50/06

(52) U.S. Cl. CPC G06Q 40/04; G05B 19/41865; G06Q 50/06

(57) ABSTRACT

The system and method of a real-time demand bidding for energy management in discrete manufacturing system calculate a first maximum profit and a first optimum machine operation schedule that indicates whether there is an operation of each machine of the discrete manufacturing system at a predetermined time interval in a state where there is no real-time demand bidding event from a utility company supplying electricity; calculate a second maximum profit and a second optimum machine operation schedule upon receiving the real-time demand bidding from the utility company; compare the first maximum profit with the second maximum profit, and when it is determined that the second maximum profit is larger than the first maximum profit, participate in the real-time demand bidding with an optimum load reducing amount; and operate each machine according to the second optimum machine operation schedule when the bidding is approved from the utility company.

### CROSS-REFERENCE TO RELATED APPLICATIONS

This application is based upon and claims the benefit of priority from the prior Korean Patent Application No. 10-2016-0119343, filed on Sep. 19, 2016, with the Korean Intellectual Property Office, the disclosure of which is incorporated herein in its entirety by reference.

### TECHNICAL FIELD

The present disclosure relates to a real-time demand bidding for energy management in a discrete manufacturing system.

### BACKGROUND

Demand Bidding (DB) is a type of Demand Response (DR) that may be considered as the most efficient mechanism to flatten the demand curve in the smart grid. DR is designed to induce changes in demand-side consumption to avoid the grid instabilities and large voltage fluctuations caused by significant imbalances in electricity generation and consumption. DR may be classified into incentive-based DR and price-based DR. Incentive-based DR provides incentive payments to consumers if they cut down the load during periods of power system stress. Price-based DR (also known as time-based DR) motivates end-users to change their energy usage patterns to respond to time-varying electricity prices.

Most prior work on DR has focused on price-based DR in the residential and commercial sectors. However, about 42.6% of global electricity consumption is by industry, and therefore DR in industrial sectors is particularly important to reduce the peak demand in power grids. There has been a technology that described barriers that prevent DR implementation in industrial system. These barriers were grouped into two aspects. First, modeling DR problems in industrial sectors should consider the interdependencies among machines in production lines. For example, a machine may not start unless its feed is provided by the feeding machine. Modeling interdependencies among machines increases the complexity of mathematical model for industrial DR compared with residential or commercial DR. Second, among different industrial applications, the industrial processes and load profiles vary considerably. It is therefore difficult to design a universal model for industrial DR. Existing approaches to industrial DR are application-specific, and specialized models have been reported for industrial refrigerated systems, the meat industry, the cement industry, and the food industry. All of these approaches were manual DR (i.e., manual decisions in response to DR events) which has limited the scope to optimize the load reduction schemes and dynamically adjust the production and energy plans, or to carry out a load shedding in real time.

In 2013, an automated DR scheme for oil refineries was proposed based on a day-ahead real-time pricing (DA-RTP), where interdependencies in the operating constraints of the process were considered. However, the production model did not consider storage units for intermediate materials, which is not realistic in practice. In 2014, there was a technology that described an automated DR scheme that divided the processing tasks into non-schedulable tasks and schedulable tasks, taking an advantage of distributed energy resources. In these technologies, the DR scheme was evaluated via a case study of oxygen generation under DA-RTP. One limitation was that the mathematical model focused on a continuous process and did not consider the operational sequence of the machines. Another issue faced by existing DA-RTP schemes is that if the electricity price falls within a period of one hour, multiple consumers may suddenly consume energy, leading to a new peak in demand. To overcome this problem, there was a technology that proposed a new pricing framework termed active time-based DR for industrial consumers, and described a case study on cement manufacturing. More recently, there was another technology that proposed a cooperative DR scheme that included a punishment mechanism to avoid the non-cooperative behavior of consumers, and applied it to industrial refrigerated warehouses.

Related technologies are described in, for example, U.S. Patent Application Publication Nos. 2013-328961A1 and 2012-098902A1.

### SUMMARY

One of the objects of the present disclosure is to solve the problems described above and provide a system and method where a consumer of electricity is notified of a demand bidding event in real-time, thereby allowing the user to promptly participate in the demand bidding.

Another object of the present disclosure is to provide a system and method that maximizes the manufacturing profit of the discrete manufacturing systems participating in the demand bidding event.

The method of real-time demand bidding of the present disclosure manages the energy of a discrete manufacturing system in which each machine processes an independent operation in a predetermined time interval. The method includes: calculating a first maximum profit and a first optimum machine operation schedule that indicates whether there is an operation of each machine of the discrete manufacturing system at a predetermined time interval in a state where there is no real-time demand bidding event from a utility company supplying electricity; upon receiving the real-time demand bidding from the utility company, calculating a second maximum profit and a second optimum machine operation schedule; comparing the first maximum profit with the second maximum profit, and when it is determined that the second maximum profit is larger than the first maximum profit, participating in the real-time demand bidding with an optimum load reducing amount; and operating each machine according to the second optimum machine operation schedule when the bidding is approved from the utility company.

A discrete manufacturing system of the present disclosure includes a plurality of machines each configured to process an independent operation for every predetermined time interval to output a product; a plurality of buffers each configured to store raw material, intermediate products and final product from each of the plurality of machines; and a controller configured to control the independent operation of each of the plurality of machines. In particular, the controller is further configured to calculate a first maximum profit and a first optimum machine operation schedule that indicates whether there is an operation of each machine of the discrete manufacturing system at a predetermined time interval in a state where there is no real-time demand bidding event from a utility company supplying electricity; calculate a second maximum profit and a second optimum machine operation schedule upon receiving the real-time demand bidding from the utility company; compare the first maximum profit with the second maximum profit, and when it is determined that the second maximum profit is larger than the first maximum profit, participate in the real-time demand bidding with an optimum load reducing amount; and operate each machine according to the second optimum machine operation schedule when the bidding is approved from the utility company.

As described above, by the real-time and automatic demand bidding method of the discrete manufacturing system, the utility company may prevent the uncertainties caused by a prediction error and secure a real-time stability in supplying the electricity.

Also, the consumers of the discrete manufacturing system may adjust the energy usage schedule in real-time, and automatically participate in the demand bidding only when a maximum profit is secured. As a result, the manufacturing profit of the discrete manufacturing system may be maximized.

### BRIEF DESCRIPTION OF DRAWINGS

FIG. 1 is a view illustrating an energy demand in a whole sale electricity market and a retail electricity market;

FIG. 2 is a view illustrating an interaction between a utility company and a consumer in the DA-DB;

FIG. 3 is a view illustrating an interaction between a utility company and a consumer in the RT-DB according to the present disclosure;

FIG. 4 is a view illustrating a system configuration of a discrete manufacturing system according to the present disclosure;

FIG. 5 is a flowchart illustrating an automated bidding process for managing the energy of the discrete manufacturing system according to the present disclosure;

FIG. 6 is a view illustrating the configuration of a Li-ion battery module proposed as a case study of the present disclosure;

FIG. 7 is a view illustrating the configuration of an assembly system of the Li-ion battery module proposed as a case study of the present disclosure;

FIG. 8 is a view illustrating the operation schedule of machines in a case where there is no RT-DB event;

FIG. 9 is a graph illustrating the electricity price and an amount of energy consumption in a case where there is no RT-DB event;

FIG. 10 is a view illustrating the operation schedule of machines in a case where there is RT-DB event;

FIG. 11 is a graph illustrating the electricity price and an amount of energy consumption in a case where the incentive rate of the RT-DB event is US$ 0.54/kWh;

FIG. 12 is a graph illustrating the electricity price and an amount of energy consumption in a case where the incentive rate of the RT-DB event is US$ 0.45/kWh;

FIG. 13 is a graph illustrating the profit according to the incentive rate;

FIG. 14 is a graph illustrating the load reduction according to the incentive rate;

FIG. 15 is a graph illustrating the production amount according to the incentive rate; and

FIG. 16 is a view illustrating a pattern of power consumption of a machine of the discrete manufacturing system according to the present disclosure.

### DESCRIPTION OF EMBODIMENTS

There have been three significant limitations to existing approaches. First, most studies in the related art have focused on continuous processes, and there is a lack of general automated DR models for discrete manufacturing. Second, most industrial DR approaches considered day-ahead DR. However, a real-time DR has greater potential for maintaining power grid balance because of the dynamic constraints of generation and the uncertainties in forecasts. Third, all previous reports on industrial DR focused on price-based DR, yet statistics for the US show that incentive-based DR contributes to 93% of peak load reduction, whereas price-based DR accounts for only 7%. Using a comprehensive model based on the principles of psychology and economy, it has been concluded that customer reactions to price-based DR differed significantly to their reactions to incentive-based DR, and incentive-based DR was found to have greater impact on customer behavior. There have been a relatively large number of studies on price-based DR, and far fewer studies on incentive-based DR. Therefore, there is significant scope for investigations of incentive-based DR with applications for industrial customers.

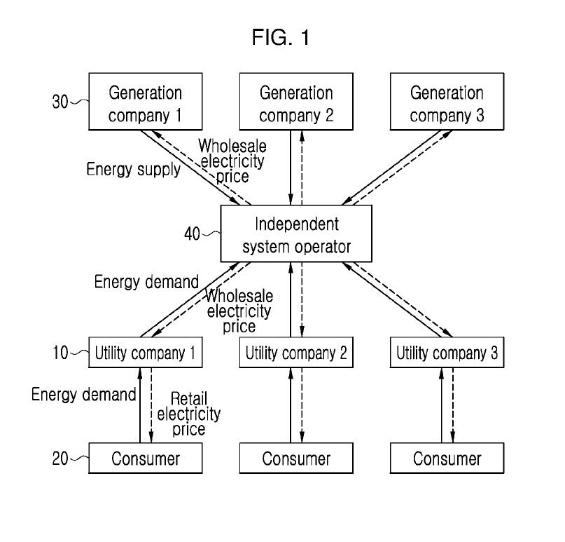

Demand bidding (DB) is an important form of incentive-based DR and there are two different types of demand bidding in the wholesale electricity market and retail market, as illustrated in FIG. 1.

As illustrated in FIG. 1, an independent system operator (ISO) 40 mediates the energy demand/supply between the utility company 10 and an electricity generation company 30 in the wholesale electricity market. In the wholesale electricity market, demand bidding refers to the process in which utility companies submit demand bids to the wholesale market in order to acquire energy. In the retail market, demand bidding refers to an incentive-based DR program, in which the utility company provides incentives to the large end-use consumers to induce them to submit curtailment capacity bids and perform a load reduction. These two types of demand bidding are significantly different in terms of their purpose and applicable scope.

The present disclosure provides a real-time demand bidding system, which refers to an incentive-based DR in the retail market. Moreover, the DB program differs from the price-based DR, because DB belongs to the incentive-based DR. Incentive-based DR may be seen as a reward-based program, whereas the price-based DR may be seen as a punishment-based program. A reward-based program is more attractive for the consumer, and especially for industrial consumers, as load reduction will inevitably result in a financial loss for industrial consumers, and this will provide a degree of compensation. Recently, a method so called day-ahead DB (DA-DB) was rolled out by the companies such as the Pacific Gas and Electric Company (PG&E) and Southern California Edison Company. However, there have been relatively few reports on DB, largely because DB as an implementation of incentive-based DR is relatively new. These reports on DA-DB are mostly focused on hotel energy management and residential energy management.

The present disclosure provides a real-time DB (RT-DB) program, which is based on existing DA-DB. The RT-DB program according to the present disclosure reduces the time used for day-ahead notification to a 10-minute in-advance notification. This enables a real-time operation in the management of demand-side energy consumption and grid stability in a manner that does not introduce significant uncertainties due to forecasting errors. The utility company announces RT-DB events during periods of peak load or grid contingencies, and industrial consumers determine whether to participate in the RT-DB event and how much load curtailment bid to submit in order to maximize their profits. If the utility company accepts the bids, the industrial consumers will commit to a load reduction by adjusting their production and energy plans.

An automated RT-DB algorithm according to the present disclosure is designed to handle an optimal load-reduction bid decision-making and dynamic adjustment of production and energy plans. It is developed based on the proposed general discrete manufacturing production model. An optimization problem, with the objective of maximizing the producer's profits as well as minimizing the energy cost, is formulated. The optimization problem is transformed into a mixed integer linear programming (MILP) problem. Solving the MILP problem allows the automated RT-DB algorithm to determine the optimal bid, with adjusted production and energy plans. The performance of the algorithm was evaluated using a case study of lithium-ion battery module manufacturing. Simulation results show that the automated RT-DB algorithm effectively decreased the load during the RT-DB events, while maximizing the profits for manufacturers.

Hereinafter, embodiments of the present disclosure will be described with reference to the accompanying drawings. The present DA-DB program will be introduced first, and then descriptions will be made on how the DA-DB program can be extended to a RT-DB program. In general, DA-DB program is a voluntary DR scheme that provides customers with opportunities to receive incentives for providing load reduction during the peak load periods.

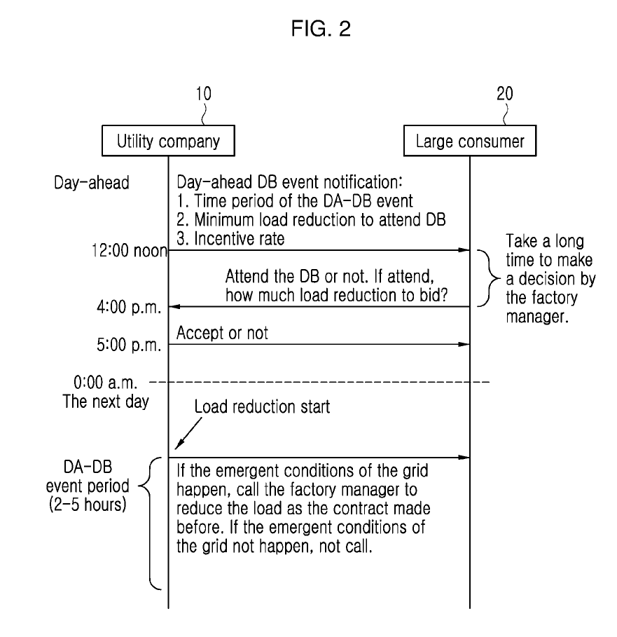

FIG. 2 is a view illustrating an interaction between a utility company and large electricity consumers. It is assumed that on 12:00 noon the previous day, the utility company announces the DA-DB event notification if at least one of the following conditions are met:

1. When it has been forecasted that generation resources may not be adequate in the following day.

2. A transmission or distribution reliability problem may arise in the next day.

3. The ISO's next-day load forecast exceeds 43,000 MW.

4. The ISO issues an alert notice or is expected to issue a warning or higher level notice for the following day.

5. The forecast temperature of the following day exceeds the threshold.

The DA-DB event notification includes three elements: the period of DA-DB event on the subsequent day (e.g., from 4:00 p.m. to 6:00 p.m.), the minimum load reduction required to participate (e.g., minimum reduction of 10 kW for each hour), and the incentive rate (e.g., 50.5 for each kilowatt-hour of load reduction).

Following the announcement of the DA-DB event, customers may decide whether to participate in the DA-DB program, and how large of a load curtailment bid to submit to the utility company. The bidding may occur during the period of 12:00 PM to 4:00 PM. Customers may receive a confirmation of bid acceptance or rejection after 5:00 PM. The following day, if the predicted conditions of the grid are met and the stability of the power grid is threatened, the utility company may call the enrolled consumers and request them to reduce their load according to the load curtailment bid contract. The consumers may receive reward payments for actual load reductions. However, even if the consumers fail to reduce the load, there is no financial penalty. The load reduction during hour t is given by the following equation (1):

ΔE(t)=CB(t)−E(t) (1)

where CB(t) is the customer baseline, which is the average energy consumption of the corresponding hours over the previous 10 days. E(t) is the actual energy consumption.

The customer rewards during hour t are given by following equation (2):

R(t)=ΔE(t)·I(t) (2)

where I(t) is the incentive rate.

One obvious limitation of the DA-DB program is that its effectiveness is strongly dependent on the grid forecasting technology. If an unforecast load peak or grid contingency occurs, it is too late to create a DA-DB event. The presend disclosure proposes the RT-DB in order to overcome this limitation and realize the DB program in near real-time (e.g., 10-15 minutes).

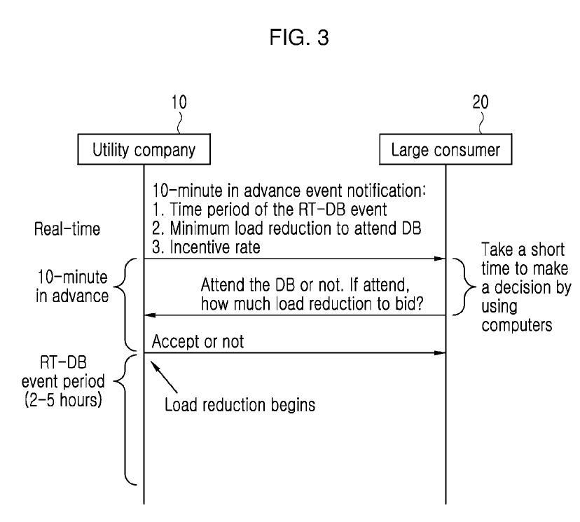

FIG. 3 is a view illustrating an interaction between a utility company and a consumer in the RT-DB according to the present disclosure. FIG. 3 illustrates that 10 minutes are sufficient for industrial consumers to make optimal load-reduction bid decisions in response to the RT-DB program by taking an advantage of the real-time communication capabilities and automatic control systems, and by using the proposed automatic RT-DB algorithm. In addition, the RT-DB algorithm according to the present disclosure may also be applied to conventional DA-DB with only a slight modification.

### Discrete Manufacturing System Model

According to the present disclosure, a mathematical model is constructed for the discrete manufacturing assembly system. An assembly line is a production system that includes processing and merging of the parts.

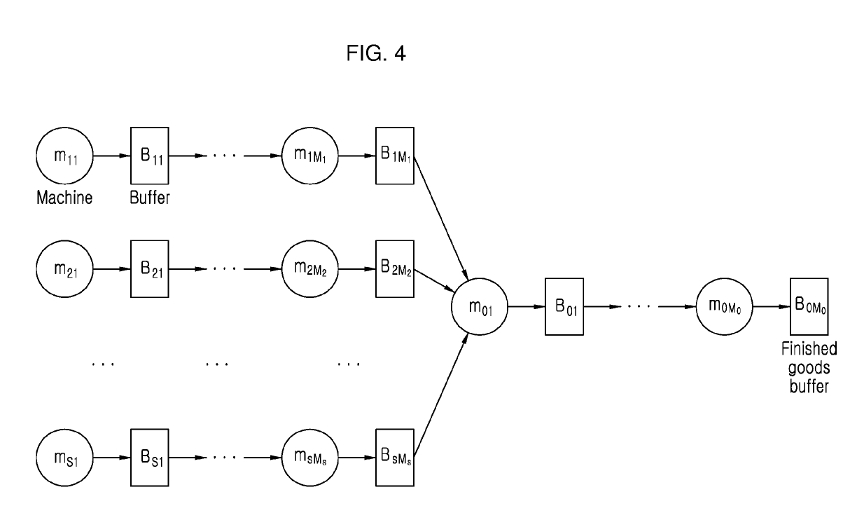

FIG. 4 is a view illustrating a system configuration of a discrete manufacturing system according to the present disclosure. Referring to FIG. 4, mᵢⱼ represents a machine, i represents the ith serial production line branch, and j represents jth machine in the ith serial production line branch. Machines mᵢⱼ, i>0 are the component machines. Machine m₀₁, is the assembly machine. Machines mᵢⱼ, i>0 are the additional processing machines for the assembled products. Bᵢⱼ is the buffer that stores the intermediate products provided by machine mᵢⱼ.

In this discrete manufacturing assembly system, each machine mᵢⱼ may be scheduled (i.e., on or off) in the timeline. Here, the timeline may be subdivided into equal-length operational time slots. Between two successive operations of the machine, the length of the time slot is Tₛ. The length of the time slot is application-specific. For different industrial applications, the length of the time slot may be 10 minutes, 15 minutes, 60 minutes and so on. In this study, Tₛ=10 min is assumed. If the time slot is too short, some machines may not finish some of the processing. However, if the time slot is too long, it will be impossible to adjust the energy usage schedule in near-real-time, and thus there will be a failure to respond to the RT-DB event. The total number of time slots in the scheduling horizon is denoted by S. For a 24-hour scheduling horizon, and with Tₛ=10 min, we have following equation (3):

$$S = \frac{24 hours}{{T}_{s}} = 144 \qquad ( 3 )$$

Next, the assembly system model is described, where two sub-models; i.e., a production model and an energy model are considered.

A. Production Model

Machines:
i) Each machine mᵢⱼ may take a fixed time period to process a part, which is termed the cycle time CTᵢⱼ.
ii) In discrete manufacturing, each machine operates in “impulse mode” (i.e., 100% on when required, and 0% when not needed) considering best efficiency. This is described by the decision variable xᵢⱼ(t) of machine mᵢⱼ at the tth time slot; i.e.,

$${x}_{ij} ( t ) = \{ \begin{matrix}1 , & machine {m}_{ij} is on \\ 0 , & machine {m}_{ij} is off\end{matrix} \qquad ( 4 )$$

Buffers:
i) Each buffer B has a capacity of CAPᵢⱼ.

Starvation Rule:
i) If the buffer Bᵢⱼ, i=0, . . . , S;j=1, . . . , Mᵢ−1 is empty, then the machine mᵢ₍ⱼ₊₁₎ is starved.
ii) The machine mᵢⱼ, i=1, . . . , S will not be starved.
iii) The assembly machine m₀₁ is starved if at least one of the buffers, Bᵢₘ, i=1, . . . , S is empty.
iv) The starved machine would stop processing and make a transition into the low power state to save energy.

Blockage Rate:
i) The machine mᵢⱼ is blocked, if buffer Bᵢⱼ, i=0, . . . , S;j=1, . . . , Mᵢ is full.
ii) The blocked machine would stop processing and make a transition into the low power state to prevent buffer overflows.

B. Production Model Constraints

During a given time slot, machine mᵢⱼ may process the quantity of parts

$${n}_{ij} ( t ) = \frac{{T}_{s}}{{CT}_{ij}} \cdot {x}_{ij} ( t ) i = 0 , … , S ; j = 1 , … , {M}_{i} \qquad ( 5 )$$

At the end of time slot t, the buffer storage is given by the following equations (6)-(8):

Bᵢⱼ(t)=Bᵢⱼ(t−1)+nᵢⱼ(t)−αᵢⱼ·nᵢ₍ⱼ₊₁₎(t) i=0, . . . ,S;j=1, . . . ,Mᵢ−1 (6)

Bᵢⱼ(t)=Bᵢⱼ(t−1)+nᵢⱼ(t)−αᵢⱼ·n₀₁(t) i=1, . . . ,S;j=Mᵢ (7)

Bᵢⱼ(t)=Bᵢⱼ(t−1)+nᵢⱼ(t) i=0; j=Mᵢ (8)

where αᵢⱼ is a coefficient describing the number of parts from Bᵢⱼ that is necessary for the machine behind Bᵢⱼ to produce one part.

Starvation Rule:

For any t, the buffer satisfies following equation (9):

Bᵢⱼ(t)ΣN⁰ (9)

Where N⁰ is the set of natural numbers that includes zero.

In addition, at the end of time slot (t−1), if Bij(t−1), (i=0, . . . S, j=1, . . . , Mi−1) is empty and cannot provide the feed to the machine mᵢ₍ⱼ₊₁₎, then machine mᵢ₍ⱼ₊₁₎ may be starved during time slot t; i.e., xᵢ₍ⱼ₊₁₎(t)=0. This rule may be described in pseudocode as follows:
1 if Bᵢⱼ(t−1)==0 (i=0, . . . ,S;j=Mᵢ−1)
2 xᵢ₍ⱼ₊₁₎(t)=0

and is described mathematically as

xᵢ₍ⱼ₊₁₎(t)≦Bᵢⱼ(t−1) i=0, . . . ,S;j=1, . . . ,Mᵢ−1 (10)

where if Bᵢⱼ(t−1)=0, then xᵢ₍ⱼ₊₁₎)(t)=0; if Bᵢⱼ(t−1)>0, and from equation (9), it can be deduced as Bᵢⱼ (t−1)≧1. If Bᵢⱼ (t−1)≧1, with equation (10) xᵢ₍ⱼ₊₁₎(t)≦Bᵢⱼ(t−1), the value of xᵢ₍ⱼ₊₁₎(t) may be determined based on equation (4) xᵢ₍ⱼ₊₁₎(t)ε{0,1}.

At the end of time slot (t−1), if Bᵢⱼ (t−1), (i=1, . . . , S;j−Mᵢ) is empty and may not provide a feed to assembly machine m₀₁, then machine m₀₁ will be starved during time slot t, i.e., xi₀₁=0. This rule may be described in pseudocode as follows:
1 if Bᵢⱼ(t−1)==0 (i=1,S;j=Mᵢ)
2 x₀₁(t)=0

and can be expressed mathematically as

x₀₁(t)≦Bᵢⱼ(t−1) i=1, . . . , S;j=Mᵢ (11)

Blockage Rule:

For any time slot t, the buffer satisfies following equation (12):

Bᵢⱼ(t)≦CAPᵢⱼ (12)

At the end of time slot (t−1), if Bᵢⱼ(t−1), (i=0, . . . , S;j=1, . . . Mᵢ) is full, then machine mᵢⱼ will be blocked, i.e., xᵢⱼ(t)=0. This rule may be described in a pseudocode as follows:
1 if Bᵢⱼ(t−1)==CAPᵢⱼ (i=0,S;j=1, . . . ,Mᵢ)
2 xᵢⱼ(t)=0

and can be expressed mathematically as

xᵢⱼ(t)≦CAPᵢⱼ−Bᵢⱼ(t−1) i=0,S;j=1, . . . ,Mᵢ (13)

C. Energy Model

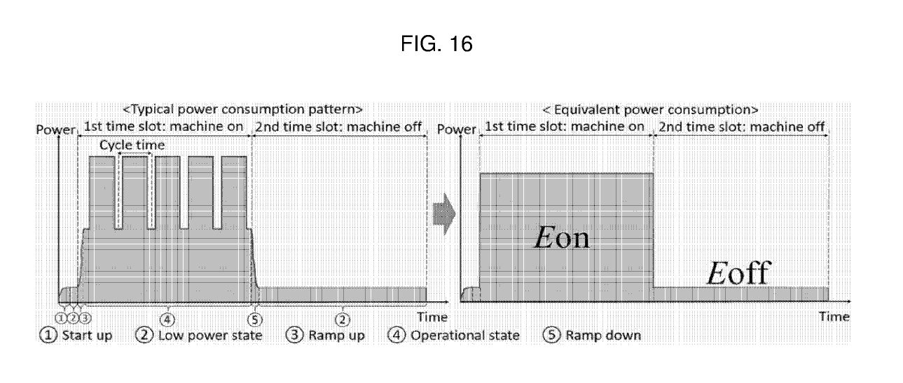

FIG. 16 illustrates the typical power consumption pattern of machines at different phases. At the beginning, the machine starts up (\textcircled{1}) and makes a transition into a low power state (\textcircled{2}). During the first time slot, if the machine is scheduled to process the workpieces, it will ramp up (\textcircled{3}) and make a transition into an operational state (\textcircled{4}). In this operational state, the machine carries out repeated processing of the workpieces. The average time to process one workpiece is called the cycle time. For the second time slot, if the machine is not scheduled to process the workpieces, it will ramp down (\textcircled{5}) and makes a transition into the low power state (\textcircled{2}). In this study, the first time slot is referred to as “machine on”, and the second time slot as “machine off”. During the “machine on” time slot, the total electricity consumption of the machine can be measured as Eon (the shaded area in the first time slot). During the “machine off” time slot, the total electricity consumption can be measured as Eoff. The right side of FIG. 16 illustrates the equivalent power consumption and their shaded areas are the same.

If the machine mᵢⱼ is scheduled “ON” during the time slot t (xᵢⱼ(t)=1), the per-time-slot electricity consumption of the machine mᵢⱼ is Eonᵢⱼ. If the machine mᵢⱼ is scheduled “OFF” during the time slot t (xᵢⱼ(t)=0), the machine will make a transition into a low power state to maintain only basic functionality and the per-time-slot electricity consumption of the machine is Eoffᵢⱼ. The energy consumption of the machine mᵢⱼ during time slot t is [Eonᵢⱼ·xᵢⱼ(t)+Eoffᵢⱼ·(1−xᵢⱼ(t))]. In this formula, if xᵢⱼ(t)=1 (the machine mᵢⱼ is scheduled “ON”), then the formula becomes Eonᵢⱼ; if xᵢⱼ(t)=0 (the machine mᵢⱼ is scheduled “OFF”), then the formula becomes Eoffᵢⱼ.

The total energy consumption of all the machines in the production line during the time slot t is

$${\sum }_{i ∈ I , j ∈ J} [ {Eon}_{ij} \cdot {x}_{ij} ( t ) + {Eoff}_{ij} \cdot ( 1 - {x}_{ij} ( t ) ) ] .$$

The total electricity cost of the production line during time slot t is

$$( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) ,$$

where p(t) is the electricity price during time slot t. The total electricity cost in the scheduling horizon (T) is

$${\sum }_{t ∈ T} ( ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) ) .$$

D. Energy Model Constraints

The total energy consumed by the factory during time slot t should be maintained below a limit Eₘₐₓ, i.e.,

$${\sum }_{i ∈ I , j ∈ J} [ {Eon}_{ij} \cdot {x}_{ij} ( t ) + {Eoff}_{ij} \cdot ( 1 - {x}_{ij} ( t ) ) ] \leq {E}_{max} , ∀ t ∈ T \qquad ( 14 )$$

Where Eₘₐₓ>0 is determined by the limits of the transmission lines in the region.

### Optimization Problem and RT-DB Algorithm

A. Formulation of the Optimization Problem

Microeconomic theory suggests that consumers of electricity, as with consumers of other commodities, increase their demand up to the point at which the marginal benefit they derive from doing so is equal to the additional costs. For example, a manufacturer may not produce products if the cost of the electricity required to produce them makes their sale unprofitable. In other words, factories determine whether to produce or not, as well as when and how to produce, in such a way as to maximize their profits. The optimization objective for factories used here is to maximize profits.

Profits are defined as revenues minus costs. Suppose that a factory produces n units of output (u₁, . . . , uₙ) and uses m units of input (n₁, . . . , nₘ). Let the value of the output goods be (v₁, . . . , vₙ) and the costs of the inputs be (c₁, . . . , cₘ). The profits π that the firm obtains may be expressed as following equation (15):

$$π = {\sum }_{i = 1}^{n} {v}_{i} \cdot {u}_{i} - {\sum }_{i = 1}^{m} {c}_{i} \cdot {n}_{i} \qquad ( 15 )$$

where

$${\sum }_{i = 1}^{n} {v}_{i} \cdot {u}_{i}$$

is the total revenue from the output goods, and

$${\sum }_{i = 1}^{m} {c}_{i} \cdot {n}_{i}$$

is the total cost of the inputs. Note that the production output should be valued at market price. The costs of the inputs should include all the expenses associated with production, including raw materials, energy and labor.

Assume that a factory participates in the RT-DB program. If no RT-DB event occurs, the optimization objective function is:

$$max π = {\sum }_{i = 1}^{n} {v}_{i} \cdot {u}_{i} - {\sum }_{i = 1}^{m - 1} {c}_{i} \cdot {n}_{i} - {\sum }_{t ∈ T} ( ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) ) \qquad ( 16 )$$

The first term is revenue; the second term is the cost of inputs excluding electricity; the third term is the cost of electricity.

This optimization problem is subject to the constraints in equations (4)-(14). These and the optimization objective function in equation (16) form a mixed integer programming (MILP) problem. Using a MILP solver, the objective (i.e., profit) may be maximized using the decision variables xᵢⱼ(t).

If an RT-DB event occurs and the factory participates in the RT-DB event, the optimization objective function becomes the following equation (17):

$$max π = {\sum }_{i = 1}^{n} {v}_{i} \cdot {u}_{i} - {\sum }_{i = 1}^{m - 1} {c}_{i} \cdot {n}_{i} - {\sum }_{t ∈ T} ( ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) ) + ( {\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) ) \cdot I ( {T}^{′} ) \qquad ( 17 )$$

The first three terms are the same as in equation (16), and the fourth term describes the incentives of the RT-DB event, in which

$${\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] )$$

is the load reduction during RT-DB event T′,

$${\sum }_{t ∈ {T}^{′}} CB ( t )$$

is the baseline load,

$${\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] )$$

is the scheduled energy consumption during the RT-DB event, and I(T) is the incentive rate during RT-DB event T′.

Because the RT-DB event also specifies a minimum load reduction LRₘᵢₙ, the constraints are not only those given in (4)-(14), but also following equation (18):

$${\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \geq {LR}_{m i n} \\ {T}^{′} ∈ \{ RT - DB event hours \} \qquad ( 18 )$$

Constraints of equations (4)-(14), (18) and the optimization objective function in equation (17), form a MILP problem. Using a MILP solver, parameters may be optimized to maximize profit by varying the decision variables xᵢⱼ(t) and the load reduction to bid

$${\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] )$$

during an RT-DB event.

Automated RT-DB Algorithm

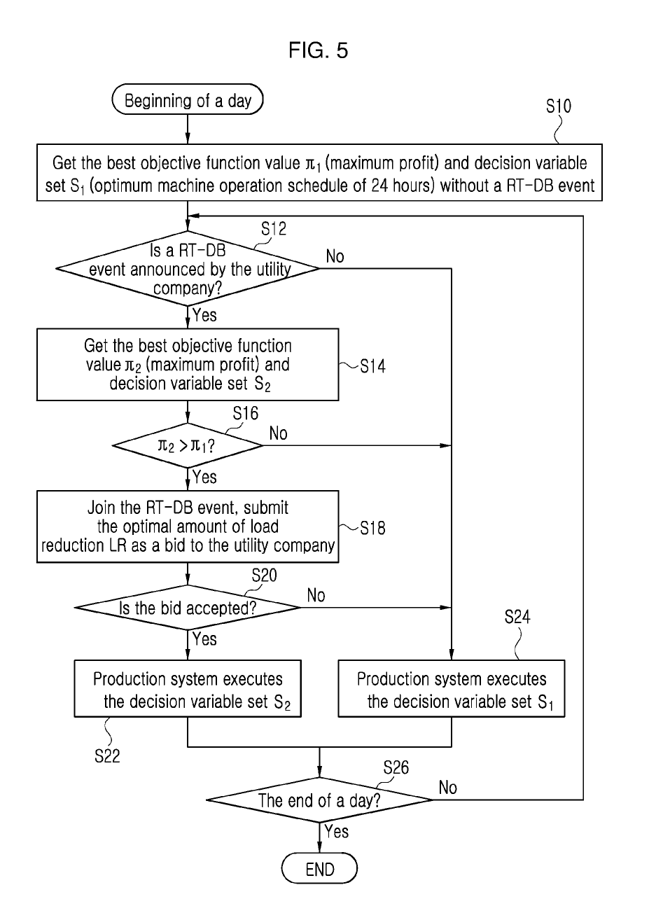

Based on the mathematical model described above, the automated RT-DB algorithm illustrated in FIG. 5 has been developed. This algorithm has been implemented using the manufacturing operations management system (MOMS), allowing the industrial consumers to determine whether to participate in the RT-DB event, as well as the optimal curtailment capacity bid to submit to the utility company and the adjustments to be made to the production and energy plans. This algorithm enables the industrial consumers not only to interact intelligently with the utility company in response to the RT-DB event, but also to generate dynamically optimized operating schedules for the machines, which maximize profits.

FIG. 3 illustrates an interaction between the utility company 10 and the consumer 20 in an RT-DB event. When explaining the automatic RT-DB algorithm in FIG. 5, the consumber 20 of FIG. 3 becomes a discrete manufacturing system. Specifically, the main subject that processes the RT-DB event by executing the RT-DB algorithm includes the utility company 10, and the control devices, computer or hardware of the discrete manufacturing system. However, for the convenience of description, it is assumed that the main subject is considered to include the utility company 10 and the discrete manufacturing system.

In FIG. 5, when a day begins, the discrete manufacturing system solves the MILP problem (e.g., equations (4)-(14), and (16)) in a state where there is no RT-DB event, and obtains the biggest objective function value π₁ (maximum profit) and determination variable set S₁ (optimum machine operation schedule of 24 hours) (S10).

The discrete manufacturing system determines whether an RT-DB event is notified from the utility company 10 (S12), and when it is determined that the RT-DB event is notified from the utility company, solves the MILP problem (equations (4)-(14), (17), and (18)) to obtain the biggest function value π₂ (maximum profit), determination variable set S₂, and an optimum load reducing amount LR (S14).

Subsequently, in order to participate in the RT-DB event, the discrete manufacturing system compares the maximum profit π₁ obtained in a state where there is no RT-DB event with the maximum profit π₂ obtained in a state where is RT-DB event (S16). When it is determined that π₂ is bigger than π₁, the discrete manufacturing system submits an optimum load reducing amount LR to participate in the bidding of the utility company (S18).

The discrete manufacturing system determines whether the bidding has been approved from the utility company (S20), and, when it is determined that the bidding is approved, operates the manufacturing system according to the determination variable set S₂ (optimum machine operation schedule) (S22).

When it is determined that the RT-DB event is not notified from the utility company, π₂ is smaller than π₁, or the bidding has not been approved, the discrete manufacturing system operates the manufacturing system according to the different determination variable set S₁ (S24).

Subsequently, the discrete manufacturing system determines whether a day ends (S26), and, when it is determined that the day ends, ends the RT-DB algorithm. When it is determined that the day does not end, the discrete system checks for the RT-DB event for every predetermined time interval (e.g., 10 minutes).

### Simulation

The present disclosure provides the modeling framework for discrete manufacturing systems participating in RT-DB schemes by considering a large-capacity manufacturing plant.

A. Case Study: Lithium-Ion Battery Manufacturing

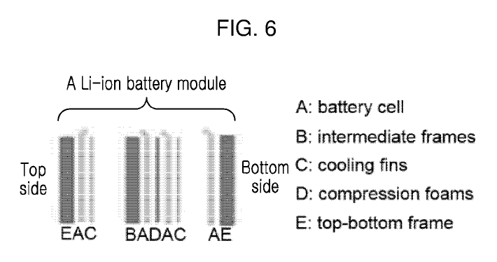

Large-capacity lithium-ion battery manufacturing is a typical example of discrete manufacturing, which includes the following four manufacturing processes: assembly, filling, formation, and grading. Assembly: a battery module has a hierarchical structure consisting of multiple battery cells (A) and ancillary components; i.e. intermediate frames (B), cooling fins (C), compression foams (D) and a frame (E), as shown in FIG. 6. These components are assembled and welded together into a battery module via a series of operations. Filling: the cells are filled with the electrolyte and sealed. Formation: the cell is cycled through at least one precisely controlled charge or discharge cycle to activate the working materials, transforming them into usable forms. Grading: based on discharge, resistance and capacitance measurements, the battery modules are graded according to performance.

The manufacturing processes may be decomposed into 10 tasks, where each is assigned to the appropriate equipment as indicated in Table I below.

TABLE I
Task Information

| Task | Task description | Machine |
|---|---|---|
| 1 | Assembly of components A & D | m₁₁ |
| 2 | Assembly of components (AD) & A | m₁₂ |
| 3 | Assembly of components B & (ADA) & C | m₁₃ |
| 4 | Assembly of components E & A | m₂₁ |
| 5 | Assembly of components (EA) & C | m₂₂ |
| 6 | Assembly of components A & E | m₃₁ |
| 7 | Assembly of (EAC) & (BADAC) & (AE) | m₀₁ |
| 8 | Filling | m₀₂ |
| 9 | Formation | m₀₃ |
| 10 | Grading | m₀₄ |

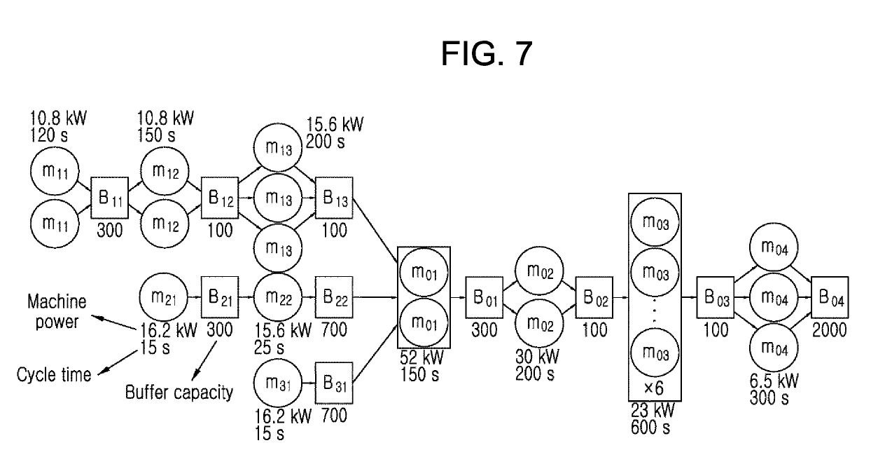

FIG. 7 shows the layout of the battery module assembly system, together with each machine's power, cycle time and the buffer capacity. In the low power state, each machine's power is 0.5 kW. It is noted that some machines are arranged in parallel to increase the production capacity of some parts of the process.

Table II lists the costs of the raw materials and labor, as well as the market price of the outputs. The other parameters used in this case study are listed in Table III.

TABLE II
Costs of Materials and the Market Price of Production Output

| Item | Unit price ($) |
|---|---|
| Battery cell (A) | 20 |
| Intermediate frames (B) | 2.5 |
| Cooling fins (C) | 0.5 |
| Compression foams (D) | 0.6 |
| Frame (E) | 3.5 |
| Labor cost for each battery module | 26 |
| Large-capacity lithium-ion battery module | 121 |

TABLE III
Parameters Used in the Case Study

| Parameter | Description | Value |
|---|---|---|
| Eₘₐₓ | Maximum power drawn | 500 kW |
| | by the factory | |
| p(t) | Hourly electricity price | DA-RTP data from [29] |

B. Results

The MILP solver, Lingo 12.0, is used to solve the proposed optimization problem. First, the scenario without the RT-DB event is described.

### Scenario 1: Without RT-DB Event

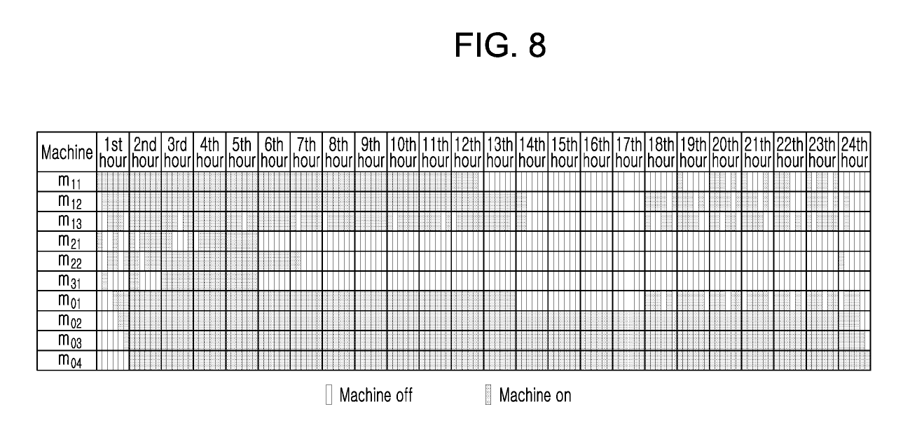

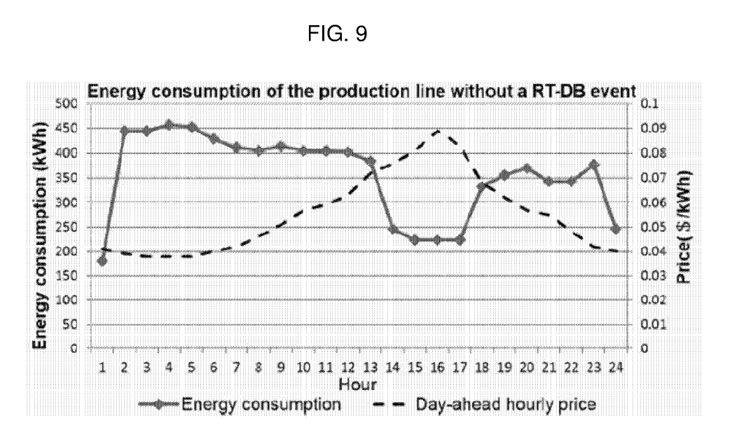

At the beginning of the day, the MILP problem described by equations (16) and (4)-(14) is solved to obtain optimized 24-hour schedules for the machines, as shown in FIG. 8. The horizontal axis shows the scheduling time horizon for 24 hours. In each hour, there are six time slots because the time slot is 10 minutes in this study. The vertical axis shows all the machines in the production line. The section where the grid is filled dark grey indicates that the corresponding machine is scheduled “ON” during this time slot. The section where the grid is filled white indicates that the machine is scheduled “OFF”. Based on this schedule, the energy consumption of the production line for each hour is illustrated in FIG. 9. During the peak hours (hours 14-17), energy consumption was lower. This not only relieves stress on the grid during peak load times, but also saves electricity costs for the consumer. Based on this optimized production schedule, the 24-hour production volume and the maximized profit are shown in the second column of Table IV.

TABLE IV
Results for Scenarios 1-3

| | Scenario 1 | Scenario 2 | Scenario 3 |
|---|---|---|---|
| Profit ($) | 2776.86 | 2780.51 | 2776.10 |
| Production | 828 units | 786 units | 822 units |
| volume | | | |
| Load reduction | — | 16^{th} hour: 212 | 16^{th} hour: 22.5 |
| bid (kW · h) | | 17^{th} hour: 35.3 | 17^{th} hour: 12.8 |
| Join the | — | Yes | No |
| RT-DB event? | | | |

Scenario 2: with a RT-DB event (incentive rate 0.54$/kW·h) during hours 16 and 17.

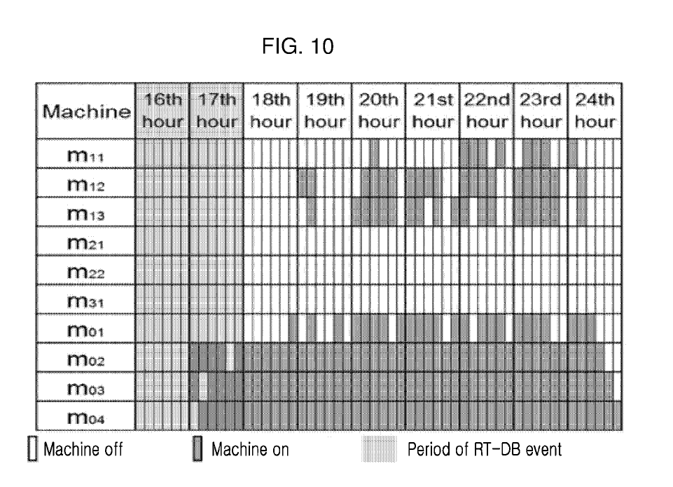

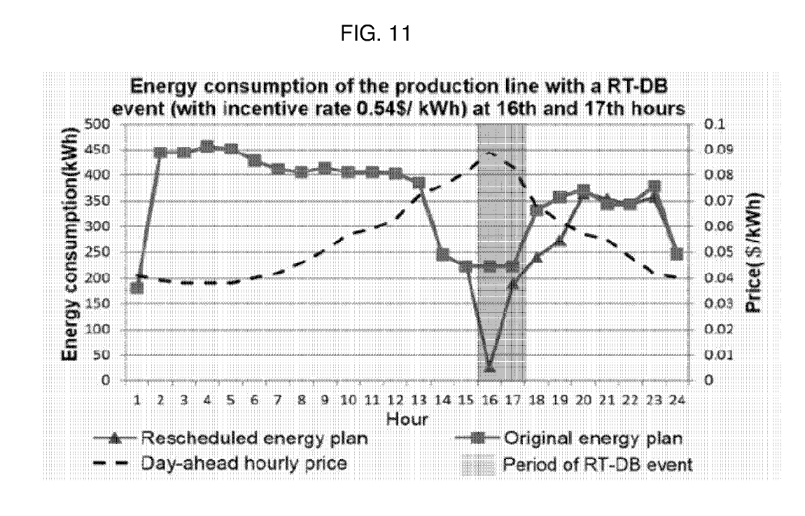

Now the RT-DB event is considered. At the start of hour 16, an RT-DB event occurs. The RT-DB event notification may include three elements; e.g., 1) the period of RT-DB event (hours 16 and 17); 2) the minimum load reductions to participate in the RT-DB program (10 kW); and 3) the incentive rate (0.54$/kW·h). The MILP problem in equations (4)-(14), (17) and (18) is solved to obtain the new optimal scheduling for the machines during hours 16-24, as illustrated in FIG. 10. During the RT-DB event (i.e., hours 16 and 17), most of the machines are halted to provide load shedding. From this new schedule, the hourly energy consumption of the production line may be calculated as illustrated in FIG. 11. The red line shows participation in the RT-DB event, that is, the load was significantly reduced compared with the original energy plan, as illustrated by the blue line during hours 16 and 17. The new optimal load curtailment bids, production volume and profit are listed in the third column of Table IV. The profit of the new schedule was $2,780.51, which exceeds that of the original plan ($2,776.86), and the plant should choose to participate in the RT-DB event with the new schedule for increased profits.

Scenario 3: RT-DB with an incentive rate of 0.45 $/kWh) during hours 16 and 17.

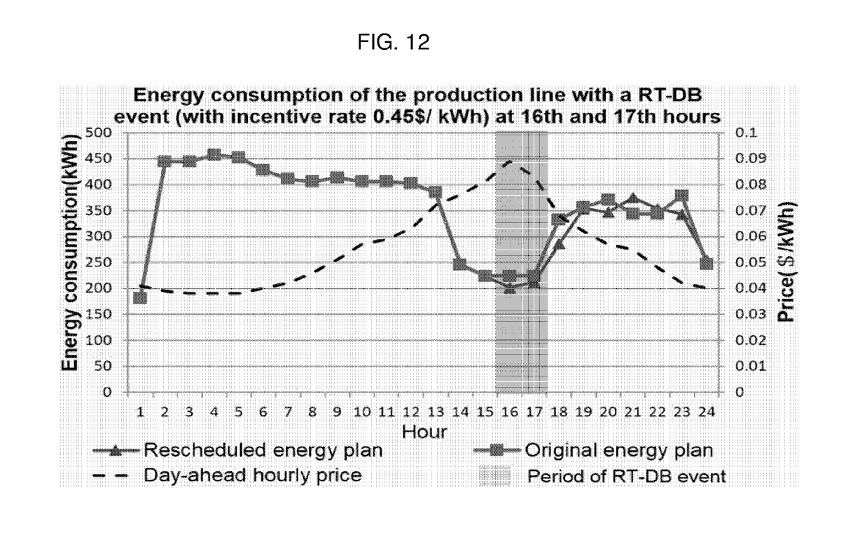

This scenario is the same as scenario (2), except it uses a lower incentive rate (0.45 $/kW·h). The optimized operation plans for the machines are obtained similarly, and the energy consumption of the production during each hour is illustrated in FIG. 12. It can be seen that the new schedule slightly reduced the load during the RT-DB event. The final column of Table IV lists the load reduction bids, the new production volume, and the profit. In this scenario, the industrial consumer would not participate in the RT-DB event because the profit of the rescheduled plan ($2,776.10) is lower than that of the original plan ($2,776.86). Therefore, the industrial consumer may continue to carry out their original plan (as in Scenario 1) without making load reductions.

In order to determine the relationships between the incentive rate and the responses of industrial consumers, further simulations were carried out with an incentive rate that was varied in the range 0.35-0.7 $/kW·h in steps of 0.05 $/kW·h.

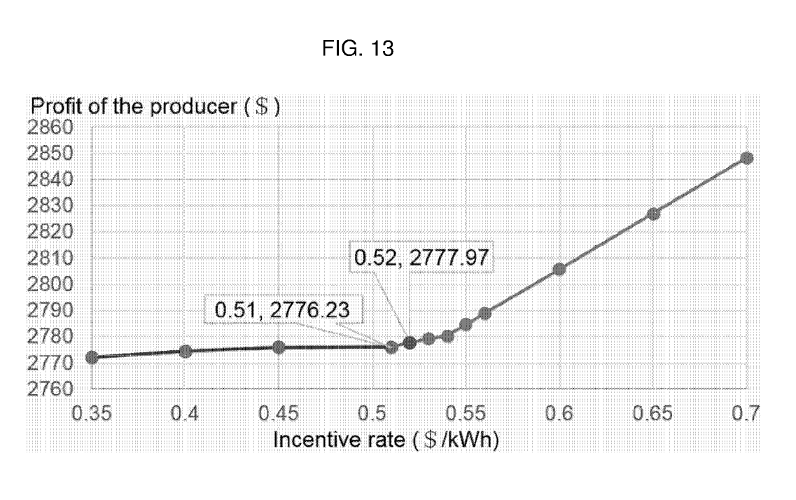

FIG. 13 illustrates the profit of the rescheduled energy for participation in the RT-DB event as a function of the incentive rate. The greater the incentive rate, the higher the marginal profit for participating in the RT-DB event. As indicated by the red points, when the incentive rates were less than or equal to 0.51 $/kW·h, the profits associated with participating in the RT-DB event were less than that of the original energy plan (2776.86 $), thus it became uneconomic to participate in the RT-DB event.

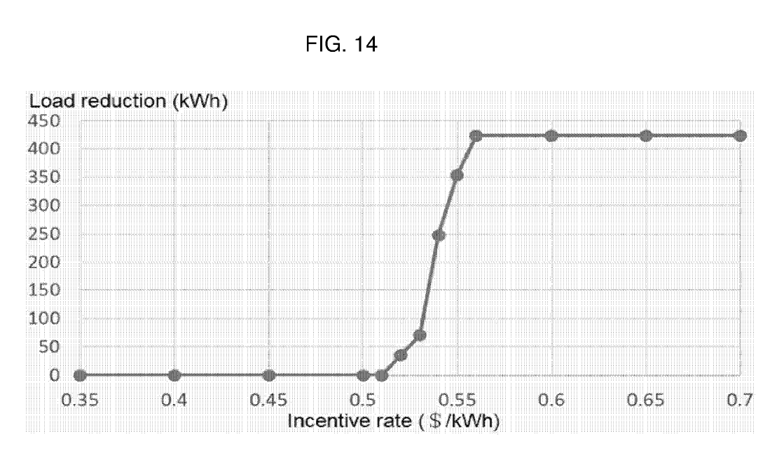

FIG. 14 illustrates the load reduction of the industrial consumer as a function of incentive rate. When the incentive rates were less than or equal to 0.51 $/kW·h, participation in the RT-DB event becomes uneconomic, and hence the consumer would carry out the original energy plan, meaning the load reduction will be zero. When the incentive rates exceed 0.51 $/kW·h, the industrial consumers would participate in the RT-DB event, and the load reduction will increase as a function of the incentive rate until it reaches the limit whereby there is no more curtailment capacity during hours 16 and 17.

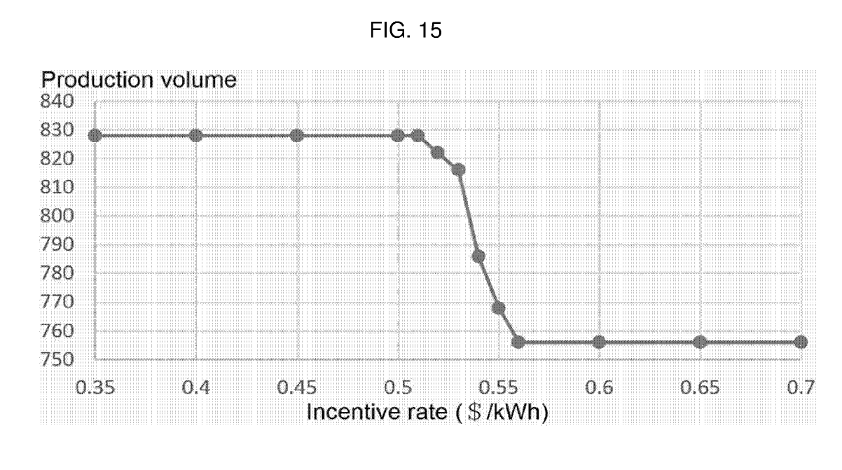

FIG. 15 illustrates the production volume as a function of the incentive rate. When the incentive rates were less than or equal to 0.51 $/kW·h, the industrial consumers would not participate in the RT-DB event, such that the production volume will be unchanged compared with the original energy plan (i.e., 828 units), as listed in the second column of Table IV. When the incentive rates were greater than 0.51 $/kW·h, the industrial consumers would participate in the RT-DB event, and the production volume will decrease. For an incentive rate greater than 0.55 $/kW·h, the rescheduled load during hours 16 and 17 reduced to the minimum, and there was no potential to further reduce capacity.

Table V lists the time for the calculations necessary to solve the optimization problem using Lingo 12.0 software on a desktop PC.

TABLE V
Computational Times for the Case Study

| | Solve the optimization | Solve the optimization |
|---|---|---|
| | problem without the | problem with an |
| | RT-DB event | RT-DB event |
| Computing | 56 | Average: 91.4 |
| time (s) | | (Max: 119; Min: 21) |

It is noted that 56 seconds were required to solve the optimization problem without the RT-DB event, and on average 91.4 seconds were required to solve the optimization problem with the RT-DB event. This indicates that the mathematical problem may be solved in a reasonable time to satisfy the near-real-time requirements of the RT-DB program (i.e., 10 minutes' advance notice).

A discrete manufacturing production model and an automated RT-DB algorithm have been described. An optimization problem with the objective of maximizing the profit for manufacturers has been formulated. Solving this problem enables an automated RT-DB algorithm to determine the optimal load-reduction bid and generate adjusted production and energy plans. The performance of the algorithm has been investigated using a case study of a lithium-ion battery module manufacturing plant. Simulation results indicates that the proposed algorithm effectively reduces the load during the RT-DB event while maximizing the profits of the manufacturer. This may be considered as a “win-win” strategy for both electricity users and the utility company. Furthermore, the relationship between the incentive rate and the demand elasticity of the consumer has been described, including an analysis of the variation in production volume and profits.

In the meantime, the method of the real-time demand bidding may be implemented with software programs to be stored in a computer-readable storage medium. For example, the storage medium may be a built-in device such as a hard disk (HD), flash memory, RAM, ROM, or an external device such as an optical disk (e.g., CD-R, CD-RW), compact flash card, smart media, and memory stick multimedia card.

The functional operation and embodiments described in the present disclosure may be implemented with digital electronic circuits, computer software, firmware or hardware, or one or more combination thereof. Also, the embodiments described in the present disclosure may be implemented with one or more computer products, that is, one or more modules regarding the commands of the computer program encoded in a tangible storage medium for a control of the operation of the data processing devices or an execution by the data processing devices.

The drawings of the present disclosure describe the operation process. This does not necessarily indicate that the operations need to be executed in that order or all of the operations are executed in order to obtain a desired result. In a specific case, a multi-taking and a parallel tasking may be advantageous.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A method for a real-time demand bidding for energy management in a discrete manufacturing system where each machine processes an independent operation in a predetermined time interval, the method comprising:
calculating a first maximum profit and a first optimum machine operation schedule that indicates whether there is an operation of each machine of the discrete manufacturing system at a predetermined time interval in a state where there is no real-time demand bidding event from a utility company supplying electricity;
upon receiving the real-time demand bidding from the utility company, calculating a second maximum profit and a second optimum machine operation schedule;
comparing the first maximum profit with the second maximum profit, and when it is determined that the second maximum profit is larger than the first maximum profit, participating in the real-time demand bidding with an optimum load reducing amount; and
operating each machine according to the second optimum machine operation schedule when the bidding is approved from the utility company.

2. The method for a real-time demand bidding according to claim 1, wherein the first maximum profit is calculated by making a value obtained by subtracting an input cost including raw material cost and labor cost and electricity cost from a gross income to be maximized.

3. The method for a real-time demand bidding according to claim 2, wherein an optimum electricity cost is determined by the first optimum machine operation schedule and an electricity cost at the predetermined time interval.

4. The method for a real-time demand bidding according to claim 1, wherein the second maximum profit is calculated by making a value, obtained by subtracting an input cost including raw material cost and labor cost and electricity cost from a gross income and adding an incentive according to an energy reducing amount, to be maximized.

5. The method for a real-time demand bidding according to claim 4, wherein an optimum electricity cost is determined by the second optimum machine operation schedule and an electricity cost at the predetermined time interval.

6. The method for a real-time demand bidding according to claim 4, wherein an optimum energy reducing amount (an optimum load reducing amount) is a value obtained by subtracting an adjusted energy amount according to the second optimum machine operation schedule from a basic energy amount of the discrete manufacturing system.

7. The method for a real-time demand bidding according to claim 1, wherein an energy consumed by the first and second optimum machining operation schedules is determined by a determination variable indicating an energy amount consumed by each machine and a fact whether a relevant machine is operated or not during the predetermined time interval.

8. The method for a real-time demand bidding according to claim 1, further comprising:
operating each machine according to the first optimum machine operation schedule while not participating in the real-time demand bidding when there is no real-time demand bidding from the utility company, when the second maximum profit is smaller than the first maximum profit, or when the utility company does not approve the bidding.

9. A discrete manufacturing system comprising:
a plurality of machines each configured to process an independent operation for every predetermined time interval to output a product;
a plurality of buffers each configured to store raw material, intermediate products and final product from each of the plurality of machines; and
a controller configured to control the independent operation of each of the plurality of machines,
wherein the controller is further configured to:
calculate a first maximum profit and a first optimum machine operation schedule that indicates whether there is an operation of each machine of the discrete manufacturing system at a predetermined time interval in a state where there is no real-time demand bidding event from a utility company supplying electricity;
calculate a second maximum profit and a second optimum machine operation schedule upon receiving the real-time demand bidding from the utility company;
compare the first maximum profit with the second maximum profit, and when it is determined that the second maximum profit is larger than the first maximum profit, participate in the real-time demand bidding with an optimum load reducing amount; and
operate each machine according to the second optimum machine operation schedule when the bidding is approved from the utility company.

10. The discrete manufacturing system according to claim 9, wherein the controller of the discrete manufacturing system operates each of the plurality of machines according to the first optimum machine operation schedule while not participating in the real-time demand bidding, when there is no real-time demand bidding from the utility company, when the second maximum profit is smaller than the first maximum profit, or when the utility company does not approve the bidding.

11. The discrete manufacturing system according to claim 9, wherein each of the plurality of machines stops operation and makes a transition into a low power state when a buffer disposed in a previous position is in a empty state or a buffer disposed in a next position is full.

12. The discrete manufacturing system according to claim 9, wherein an assembly machine that makes a complex object by combining a plurality of output products output from the plurality of machines stops operation and makes a transition into a lower power state.

13. The discrete manufacturing system according to claim 9, wherein the controller is further configured to calculate the second maximum profit by making a value, obtained by subtracting an input cost including raw material cost and labor cost and electricity cost from a gross income and adding an incentive according to an energy reducing amount, to be maximized.

14. The discrete manufacturing system according to claim 9, wherein the controller is further configured to determine the optimum load reducing amount by adjusting an operation schedule of the plurality of machines that indicates whether each of the plurality of machines is operated or not in order to calculate a maximum profit.

15. The discrete manufacturing system according to claim 14, wherein the discrete manufacturing system responds to the real-time demand bidding event of the utility company, and when the utility company approves a bidding, operates the plurality of machines according to the adjusted operation schedule.

16. A method for a real-time demand bidding by a utility company supplying electricity for energy management in a discrete manufacturing system, the method comprising:
receiving, from the utility company, a real-time demand bidding event including an event time, a minimum reducing energy amount and an incentive rate;
calculating a maximum profit to participate in the real-time demand bidding event by considering the event time, minimum reducing energy amount and incentive rate; and
when it is determined that the maximum profit calculated in the calculating is larger than a maximum profit calculated prior to the real-time demand bidding event, participating in the real-time demand bidding event.

17. The method for a real-time demand bidding according to claim 16, wherein the maximum profit prior to the real-time demand bidding event is calculated based on an equation of:
$$max π = {\sum }_{i = 1}^{n} {v}_{i} \cdot {u}_{i} - {\sum }_{i = 1}^{m - 1} {c}_{i} \cdot {n}_{i} - {\sum }_{t ∈ T} ( ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) )$$
wherein the first term is a revenue, the second term is an input cost excluding electricity, and the third term is a cost of electricity.

18. The method for a real-time demand bidding according to claim 16, wherein the maximum profit to participate in the real-time demand bidding is calculated based on an equation of:
$$max π = {\sum }_{i = 1}^{n} {v}_{i} \cdot {u}_{i} - {\sum }_{i = 1}^{m - 1} {c}_{i} \cdot {n}_{i} - {\sum }_{t ∈ T} ( ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) \cdot p ( t ) ) + ( {\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] ) ) \cdot I ( {T}^{′} )$$
wherein the first term is a revenue, the second term is an input cost excluding electricity, the third term is a cost of electricity, a fourth term is an incentive of the real-time demand bidding event,
$${\sum }_{t ∈ {T}^{′}} CB ( t ) - {\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] )$$
is an energy reducing amount during the real-time demand bidding T′,
$${\sum }_{t ∈ {T}^{′}} CB ( t )$$
is a basic energy amount, and
$${\sum }_{t ∈ {T}^{′}} ( {\sum }_{i ∈ I , j ∈ J} [ {Eon}_{ij} \cdot {x}_{ij} ( t ) + {Eoff}_{ij} \cdot ( 1 - {x}_{ij} ( t ) ) ] )$$
is a scheduled event energy consumption during the real-time demand bidding.

19. A non-transitory computer readable medium storing a computer program that, when executed, causes a computer to perform a process for a real-time demand bidding for energy management in a discrete manufacturing system where each machine processes an independent operation in a predetermined time interval, the process comprising:
calculating a first maximum profit and a first optimum machine operation schedule that indicates whether there is an operation of each machine of the discrete manufacturing system at a predetermined time interval in a state where there is no real-time demand bidding event from a utility company supplying electricity;
upon receiving the real-time demand bidding from the utility company, calculating a second maximum profit and a second optimum machine operation schedule;
comparing the first maximum profit with the second maximum profit, and when it is determined that the second maximum profit is larger than the first maximum profit, participating in the real-time demand bidding with an optimum load reducing amount; and
operating each machine according to the second optimum machine operation schedule when the bidding is approved from the utility company.
